(19) United States
(12) Patent Application Publication
(10) Pub. No.: US 2025/0262838 A1
(43) Pub. Date: Aug. 21, 2025

(54) CURVED LAYERED PRODUCT

(71) Applicant: Buza NICOLAE, Bucuresti (RO)

(72) Inventor: Buza NICOLAE, Bucuresti (RO)

(21) Appl. No.: 19/054,517

(22) Filed: Feb. 14, 2025

(30) Foreign Application Priority Data
Feb. 15, 2024 (RO) U 2024 - 00007

(51) Int. Cl. B32B 5/18; B32B 3/30; B32B 7/12

(52) U.S. Cl. CPC B32B 5/18; B32B 3/30; B32B 7/12; B32B 2250/03; B32B 2266/0207; B32B 2266/0278; B32B 2305/022; B32B 2307/304; B32B 2307/7376

(57) ABSTRACT

The disclosure refers to the creation of a curved laminated panel from a flat laminated panel or a panel with another type of curvature. The flat or differently curved laminated panel has two outer layers in the form of malleable sheets and an inner layer. Forces are applied to the panel in the form of a distributed load, which determines the desired curvature and radius of the curved layered product, representing the final product.

### BACKGROUND

### Technical Field

The disclosure of the curved layered product pertains to construction elements such as curved panels made of multiple layers, used in the construction industry.

### Description of the Related Art

Previous disclosures for creating curved layered products involve two outer layers made of metal sheets and an interior layer that provides thermal or insulating properties. However, these disclosures have the drawback of requiring the pre-curving of the laminated structure's elements, specifically the metal sheets, followed by the bonding and filling with an insulating layer. This complicates the manufacturing process for curved laminated structures and results in high production costs.

One such disclosure is described in GB 2374878 A, titled “Composite panel for curved roofs or curved walls”, published on Oct. 30, 2002. It concerns a composite panel used for creating curved roofs or walls. The panel consists of an outer first layer, a second inner layer, and an insulating layer positioned between the two. The second layer initially has a number of V-shaped indentations, which allow for the application of a force to bend the panel in a direction that is perpendicular to the indentations, changing it from a primarily flat state to a curved one. These indentations also function to prevent the layer from breaking during the bending process. The two layers are made of sheet metal, and the insulating material is either polyurethane foam or a similar material, which adheres to the layers. The disclosure also includes a method for constructing a curved wall or roof structure, which involves providing a support structure, placing the panel in its initial flat state onto the support, and then deforming it by applying force to the second layer in accordance with the desired curvature. Compressing the second inner layer to the curvature creates a force that pushes the second layer more firmly into the insulating material, counteracting any forces that could lead to delamination. The spacing between the indentations along the panel varies according to the design specifications and the intended use of the panel. For a higher degree of curvature, the distance between the indentations is typically smaller.

Another known disclosure is GB 2262754 A, titled “Curved facade panel,” published on Jun. 30, 1993. This disclosure describes a curved panel consisting of two outer faces and an insulating core, with the outer face featuring indentations covering nearly the entire surface, formed as a result of bending the panel. The two faces are typically made of metal, with a filler material possessing thermal and acoustic insulating properties inserted between them.

### BRIEF SUMMARY

The technical problem addressed by the disclosure is the creation of a curved laminated panel from a flat, corrugated laminated panel, or the modification of the curvature of an existing curved laminated panel.

The curved layered product according to the disclosure comprises a first layer of a specified thickness, a second layer of the same or a different thickness, and a third internal filler layer of a specified thickness. A force, applied as a distributed load, acts on the first layer, causing a local depression in the first layer. This force is absorbed by the tension in the third layer's material, which transmits the stress to the first layer and passes it through the third layer to the second layer. This results in a moment that forms the curvature of the third layer, accompanied by changes in the density distribution within the third layer. Through the adhesive forces between the third and second layers, the second layer also becomes curved. This force is applied progressively across the entire width, length, or at an angle to the panel, resulting in parallel or non-parallel embossments. This is achieved by gradually moving the panel or the force. The necessary radius is determined by correlating the magnitude of the force with the step size.

The application of the disclosure provides the following benefits:
increased productivity;
reduced costs of curved panels; and
allows the use of standard flat laminated panels in curved panels, with minimal costs, for any desired radius.

### BRIEF DESCRIPTION OF THE SEVERAL VIEWS OF THE DRAWINGS

FIG. 1 is a section of the laminated panel before curving.

FIG. 2 is a section of the curved laminated panel.

### DETAILED DESCRIPTION

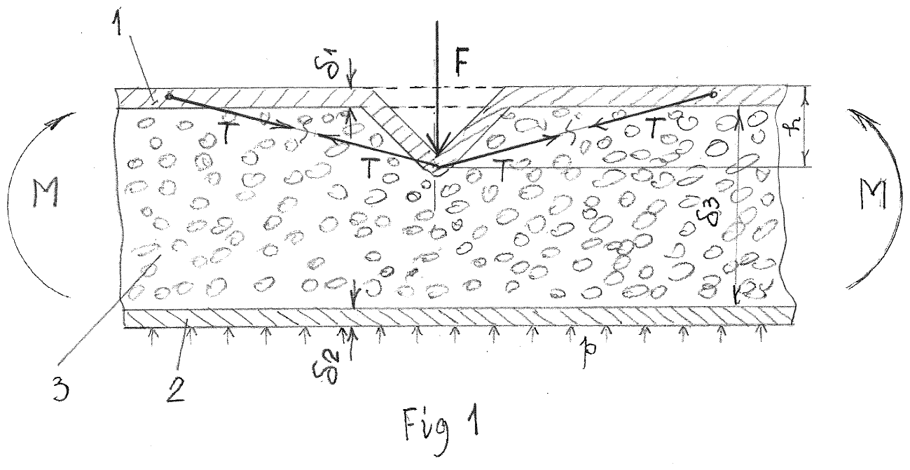

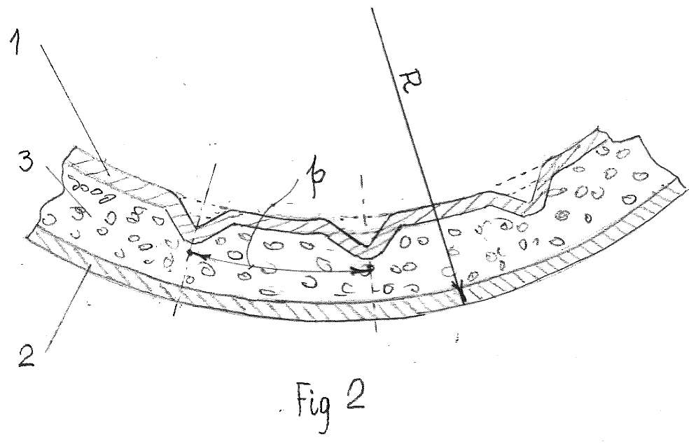

Referring to FIGS. 1 and 2, the curved layered product according to the disclosure includes the following steps:

A laminated panel is used as the layered structure, consisting of two outer flat or corrugated metal sheets 1, 2 with thickness 81, between which a filler material 3, consisting of polyurethane foam with thickness 83, is placed. This filler material adheres to the outer layers 1 and 2.

The laminated panel is placed horizontally on a rigid support, such as a wooden table, which can be either fixed or movable. The panel's length or width will correspond to the direction of movement of the support or the applied distributed load, depending on whether the panel is curved lengthwise or widthwise. Additionally, depending on the desired curvature, the panel may initially be placed at an angle on the rigid support, with the distributed load F applied perpendicular to the direction of movement.

A distributed load F is applied to the upper surface of the top sheet 1, with thickness 81, sequentially along the entire length/width of the panel, with a step size p. This distributed load causes a local depression of the top layer 1 by a depth h, forming symmetrical, parallel indentations (embossments) that result in the curvature of the top layer 1 to achieve a predefined radius R; Furthermore, depending on the desired shape of the curved panel, the distributed load F may be applied at an angle to the direction of movement, and the indentations may be asymmetric and/or non-parallel.

The distributed load F is absorbed by the stress T in the material of the third filler layer 3, which then applies stress to the first layer 1 and transmits it through the third layer's material 3 to the second layer 2. This creates a moment M that curves the third layer 3, along with changes in the density distribution within this third layer 3, and through the adhesive forces between the second outer layer/lower plate (beneath) 2 and the filler layer 3, the lower layer (2) is also curved;

In this specific embodiment, the indentation takes the shape of a “V,” and the depth size (h), correlated with the distributed load F, defines the desired radius R of the curved laminated panel;

The distributed load F is applied progressively across the entire length or width of the panel, either by moving the distributed load F or by moving the panel according to the established step size p. In the embodiment where a curved laminated panel is desired in the form of a cylindrical crown segment, the step size p is constant and a submultiple of the length/width of the panel. The step size p, correlated with the distributed load (magnitude of the load) F, determines the radius R of the curved layered product, which represents the final product.

The step size p, which represents the distance between two adjacent indentations, can also vary, but with symmetric variation relative to the panel's median axis, parallel to the indentations, if the goal is to produce a laminated panel in the shape of a cylindrical parabolic part of a liner (a crown segment).

The curved layered product consists of a first exterior layer 1, located on the inside of the curved section, with thickness 81, featuring symmetrical or asymmetrical indentations relative to the panel's median axis, created by applying a distributed load F. The second exterior layer 2, located on the outside of the curved section, has thickness 82, which may be equal to or different from the thickness of the first layer, and the third filler layer 3, of thickness 83, placed between the first two layers and bonded to them. A distributed load F is applied to the first layer 1, causing a local depression of the first layer by a depth h, causing it to bend. The distributed load F is absorbed by the stress T in the material of the third filler layer 3, which transmits the stress to the first layer 1 and through the material of the third layer 3 to the second layer 2. This results in a moment M that curves the second layer 2, which remains smooth; along with changes in density distribution in the third layer 3, and through the adhesive forces between the layers, the entire panel is curved. The distributed load F applied to the first layer 1, with a step P, correlates the step size with the distributed load, forming the established radius R.

The curved layered product may have outer layers 1 and 2 made of metal or other malleable materials, with the inner layer 3 made of filler materials such as polyurethane foam, polystyrene, mineral wool, or similar.

The curvature size R of the curved layered product depends on the local depression h of the first layer 1 and the magnitude of the distributed load F applied to the first layer 1.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A curved layered product, comprising:
a first outer layer;
a second inner layer which, in its initial form, features a multitude of indentations; and
an insulating layer made of polyisocyanurate foam or polyurethane foam, positioned between the two layers and adhering at least to the second layer,
wherein the indentations in the second layer are used to apply a force for deforming or bending the panel, in a direction transverse to the indentations,
wherein the second layer is a sheet, initially flat, made of a malleable material with a preset thickness, located towards the interior of the curved section, and after bending, the second layer features symmetrical indentations arranged at a constant or variable pitch, created by applying a distributed load transversally across the entire width, which causes its curvature,
wherein the outer layer is in the form of an initially flat sheet, made of a malleable material with a thickness that is either equal to or different from the first layer, and located towards the exterior of the curved section, and
wherein the third filler layer comprises at least one of polyurethane foam, polystyrene, mineral wool, foamed rubber and bonds with the first and second layers with a thickness.

2. The curved layered product of claim 1, wherein the indentations created by the distributed load are configured to be arranged obliquely.

3. The curved layered product of claim 2, wherein the indentations created by the distributed load are asymmetric and/or non-parallel.
